(19) United States
(12) Patent Application Publication
(10) Pub. No.: US 2026/0013445 A1
(43) Pub. Date: Jan. 15, 2026

(54) PLANT POT CARRIER

(71) Applicant: PLANTOPIA ECO PULP LTD, Manchester (GB)

(72) Inventor: Christopher Partington HALEY, Lancashire (GB)

(21) Appl. No.: 18/993,717

(22) PCT Filed: Jul. 7, 2023
(86) PCT No.: PCT/GB2023/051796

§ 371 Date: Jan. 13, 2025

(30) Foreign Application Priority Data
Jul. 12, 2022 (GB) 2210213.1

(51) Int. Cl. A01G 9/04

(52) U.S. Cl. CPC A01G 9/045

(57) ABSTRACT

A carrier tray for carrying multiple plant pots includes a plurality of sockets for receiving plant pots, where the sockets include a first set of planar areas, arranged alternately and with a second set of planar areas, with a concertinaed section provided between each planar area of the first set and of the second set. The first set of planar areas are of variable geometry and can be urged from a first, kind angle to the vertical when the socket is unfulfilled, to a second, smaller angle to the vertical when a pot is inserted into the socket.

The present invention relates to multi-compartment carrier tray. Certain embodiments of the present invention relate to an improved multi-compartment carrier tray for transporting plant pots.

### PRIOR ART

In the horticulture industry, it is known to transport multiple plant pots in a multi-compartment carrier tray. These carrier trays are typically formed of moulded pulp, and define multiple sockets, wherein a plant pot can be inserted into each socket.

Multi-compartment carrier trays are also used in the fast food industry, for example for carrying takeaway drinks cups.

Multi-compartment carrier trays must by sufficiently strong and rigid. It is also useful if trays can be stacked on top of one another in a close nested configuration, to allow for economic delivery of new, unfulfilled trays.

Further design considerations applied to multi-compartment carrier trays may be specific to the intended use of the tray. For example, a carrier tray for transporting hot drinks may be designed to provide sufficient additional material beyond the sockets so as to allow a user to hold the tray without risk of contact with the hot drinks cups.

A specific design consideration for the horticulture industry is to maximise the number of plant pots per unit area, e.g. per trolley shelf.

It is an aim of certain embodiments of the present invention to provide an improved multi-compartment carrier tray for plant pots.

Embodiments of the present invention provide an improved carrier tray for multiple plant pots. The sockets of the present invention are of variable geometry, enabling trays to be stacked and transported in a closely nested configuration before use, and also enabling the trays to securely accommodate plant pots having a range of different steepness of side walls, i.e. plant pots comprising side walls which are arranged at a different angles to a vertical axis.

The carrier tray of the present invention also be used to accommodate plant pots of a variety of different heights.

The carrier tray of the present invention can therefore be used to transport of wide range of different plant pot, i.e. within a range of side walls angles and a range of pot height.

Furthermore, the arrangement of the sockets of the carrier tray of the present invention maximises the number of plant pots which can be carrier per tray, thereby also maximising an amount of pots per trolley shelf.

In a first aspect, the present invention comprises a tray for carrying plant pots, comprising a top, a base, an outer periphery, and a plurality of sockets each of which can receive a plant pot; wherein the sockets each comprise: a socket base, undersides of the socket bases collectively forming the base of the tray; a first set of planar areas, each of which extend from the top of the tray part way towards the socket base, and a second set of planar areas, each of which extend from the top of the tray to the socket base; wherein planar areas of the first set are arranged alternately planar areas of the second set, and wherein a concertinaed section is provided between a one of the first set of planar areas and an adjacent one of the second set of planar areas; and wherein, when the tray is in a first, unfulfilled state, the first set of planar areas are each arranged at a first angle to a central vertical axis through a central point of the socket, and when the tray is in a second filled state, the first set of planar areas are each arranged at a second angle to the central vertical axis of the socket, wherein the second angle is less than the first angle.

Each of the first set of planar areas and the second set of planar areas may comprise four planar areas.

The first may angle is 5°. The second angle may be 12°.

In a further aspect, the present invention comprises a stack of trays in accordance with the first aspect, wherein each socket of a first tray in the stack is located in a corresponding socket of a further tray located immediately below the first tray in the stack.

In a further aspect, the present invention comprises a method of use of a tray in accordance with the first aspect claimed in claim 1, comprising inserting a plant pot into a socket of the tray, wherein each of the concertinaed sections of the socket comprises folds of material, and wherein insertion of the plant pot into the socket causes a side wall of the pot to contact and apply pressure to each of the first set of planar areas, thereby causing the folds of material to be urged together in each respective concertinaed section, thereby enabling each of the first set of planar areas to be urged away from the central vertical axis of the socket, and wherein when insertion of the plant pot into the socket is complete and the plant pot is fully inserted in the socket, the first set of planar areas is each arranged at the second angle.

The method may comprise a subsequent step of removing the plant pot from the socket thereby causing the concertinaed sections to relax and urge the first set of planar areas back towards the central vertical axis of the socket, and wherein when removal of the plant pot from the socket is complete, the first set of planar areas is each arranged at the first angle.

In a further aspect, the present invention comprises a system comprising a tray according to the first aspect, and at least one plant pot which is insertable in socket of the tray; wherein when the at least one plant pot is present in a socket of the tray and a base of the plant pot is in contact with the socket base, each of the first set of planar areas is in contact with an outer wall of the plant pot, and, an angle of the outer wall of the plant pot is equal to the second angle of the first set of planar areas to the vertical central axis of the socket.

When the at least one plant pot is present in the socket of the tray, an edge of a rim of the at least one plant pot may be coincident with a vertical plane containing the outer periphery of the tray.

When a plant pot is present in each one of the sockets, an edge of a rim of each of the plant pots may lie within a footprint defined within the periphery vertical plane defined by the outer periphery of the tray.

An edge of a rim of the at least one plant pot may be immediately adjacent to an edge of a rim of a further plant pot in an adjacent socket.

The or each plant pot may be between 10 cm and 13 cm in height. The side wall of the or each plant pot may be at an angle of between 5° and 12° to a vertical axis.

Embodiments of the present invention will now be described hereinafter, by way of example only, with reference to the accompanying drawings in which:

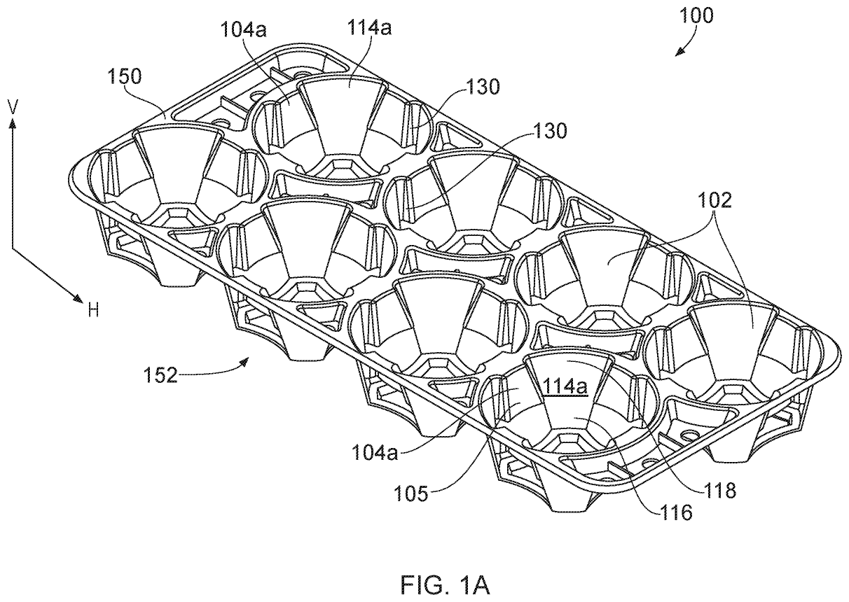

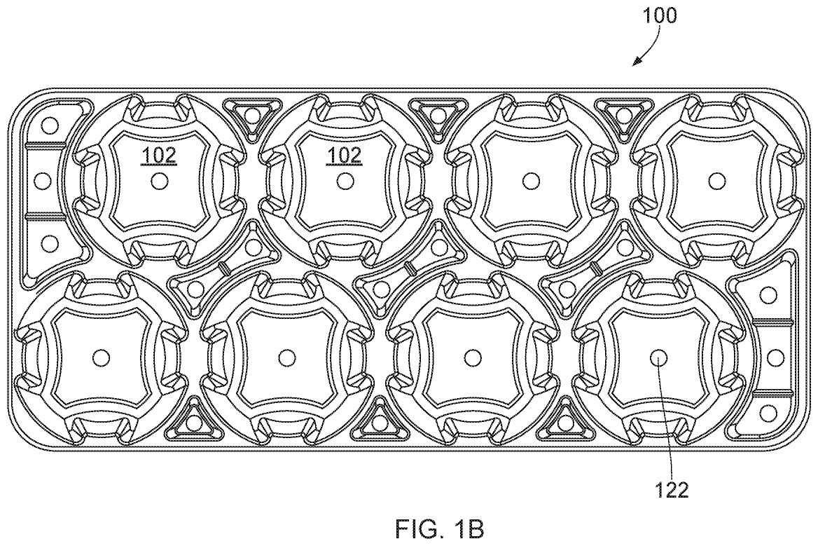

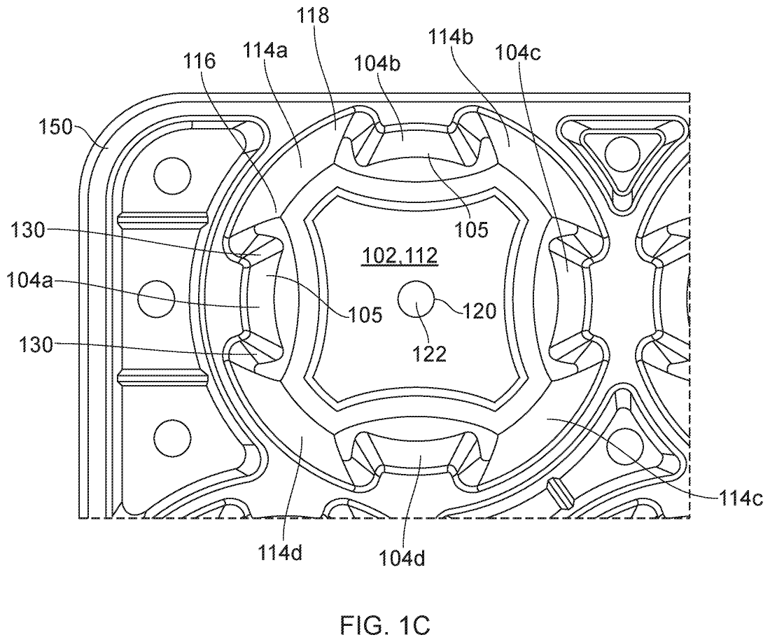

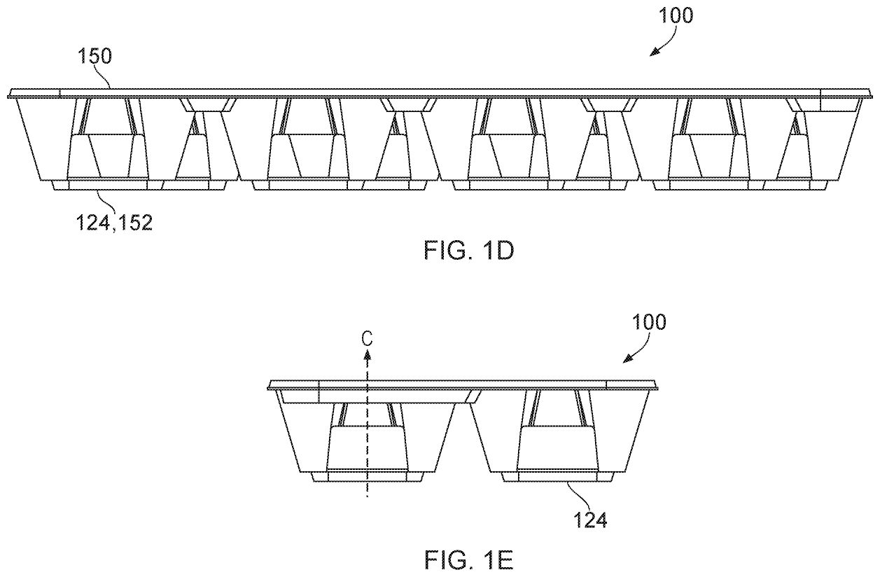

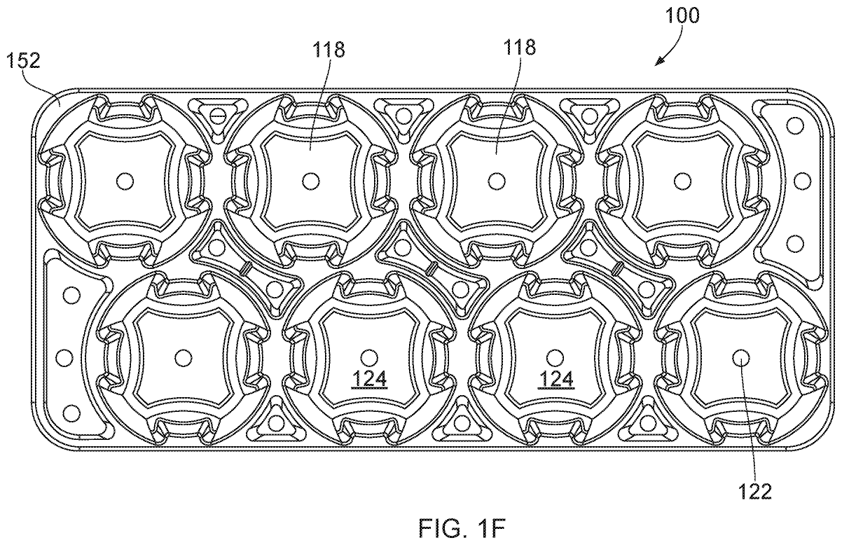

FIG. 1A is an isometric view of a multi-compartment carrier tray in accordance with the present invention, without pots;

FIGS. 1B and 1C are top views of multi-compartment carrier tray of FIG. 1A;

FIG. 1D is a detailed view of a single socket front view of multi-compartment carrier tray of FIG. 1A;

FIG. 1E is an end view of multi-compartment carrier tray of FIG. 1A;

FIG. 1F is an underneath view of multi-compartment carrier tray of FIG. 1A;

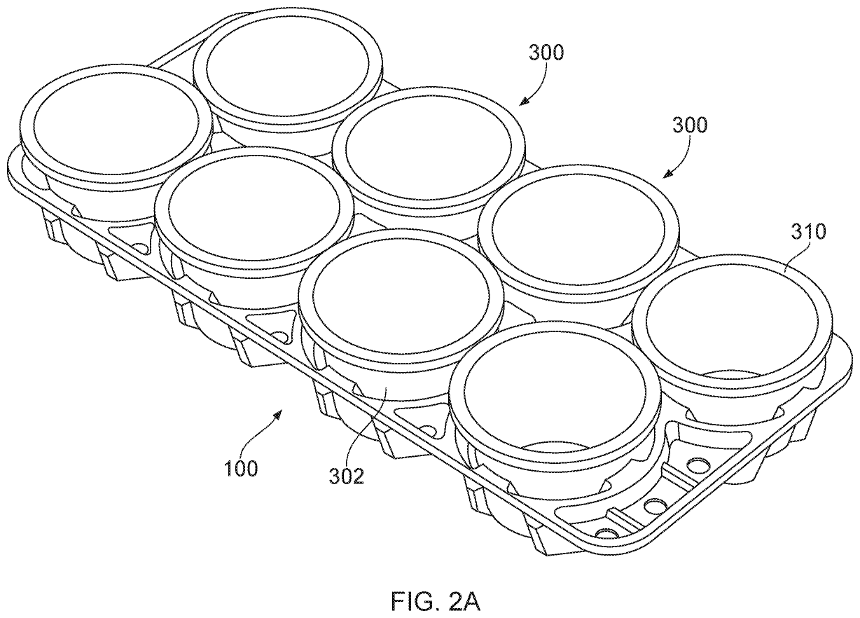

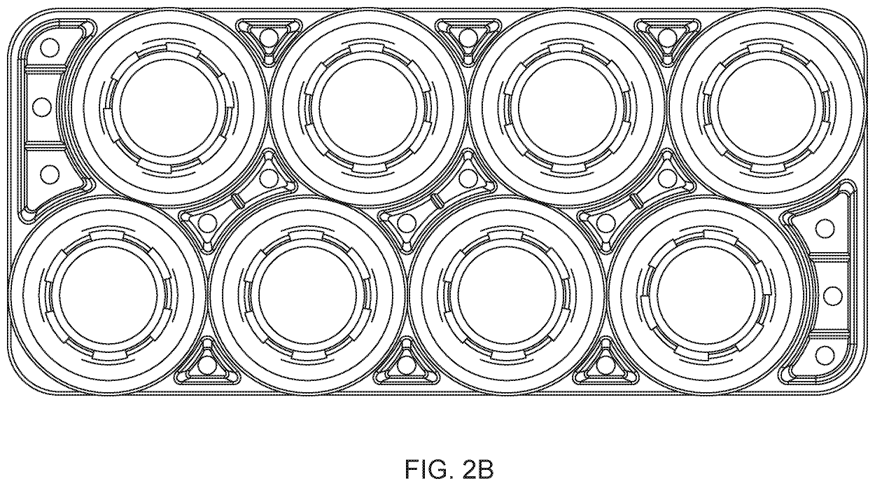

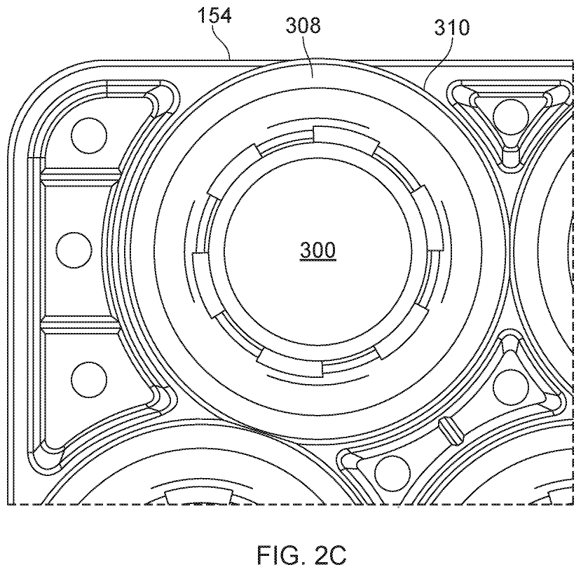

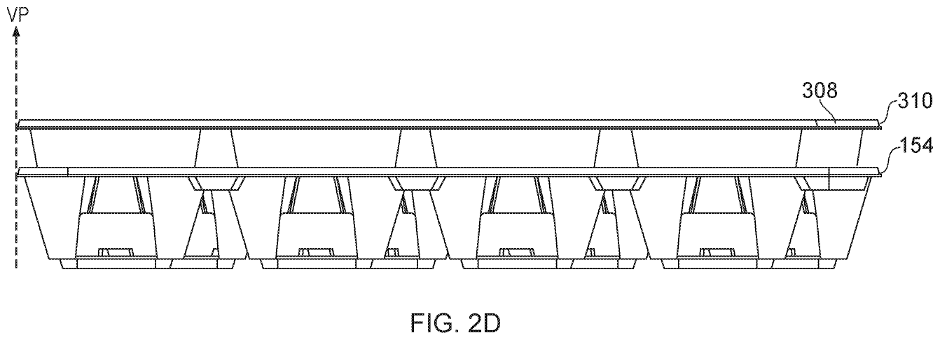

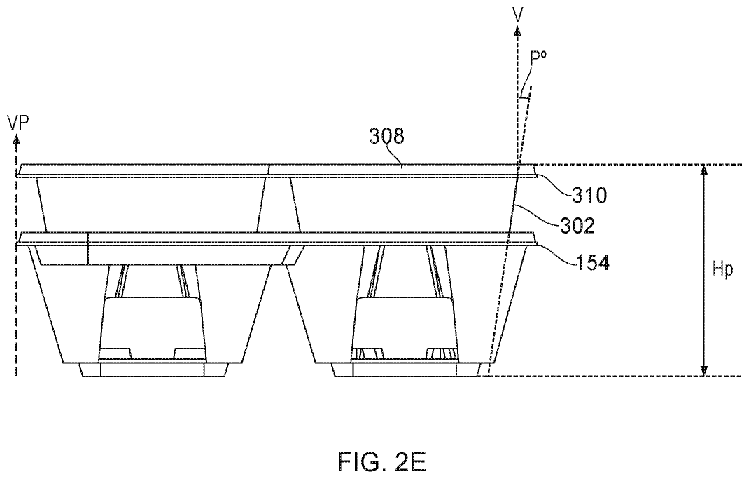

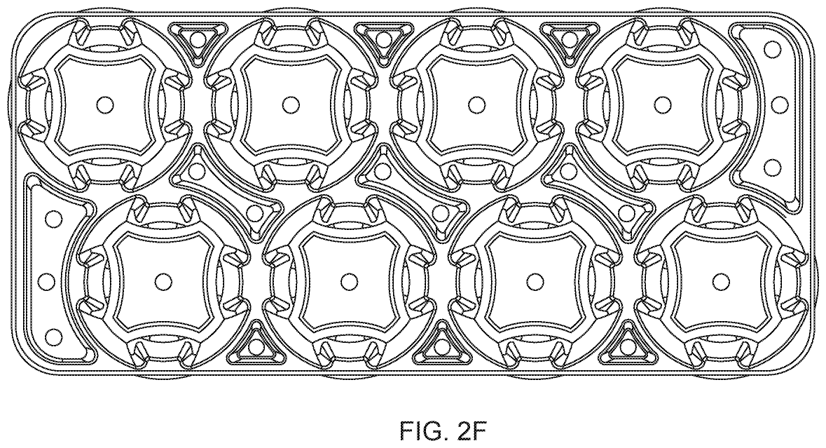

FIG. 2A is an isometric view of the multi-compartment carrier tray of FIG. 1A, with pots inserted into sockets;

FIGS. 2B and 2C are top views of multi-compartment carrier tray of FIG. 1A, with pots inserted into sockets;

FIG. 2D is a front view of multi-compartment carrier tray of FIG. 1A, with pots inserted into sockets;

FIG. 2E is an end view of multi-compartment carrier tray FIG. 1A, with pots inserted into sockets;

FIG. 2F is an underneath view of multi-compartment carrier tray of FIG. 1A, with pots inserted into sockets;

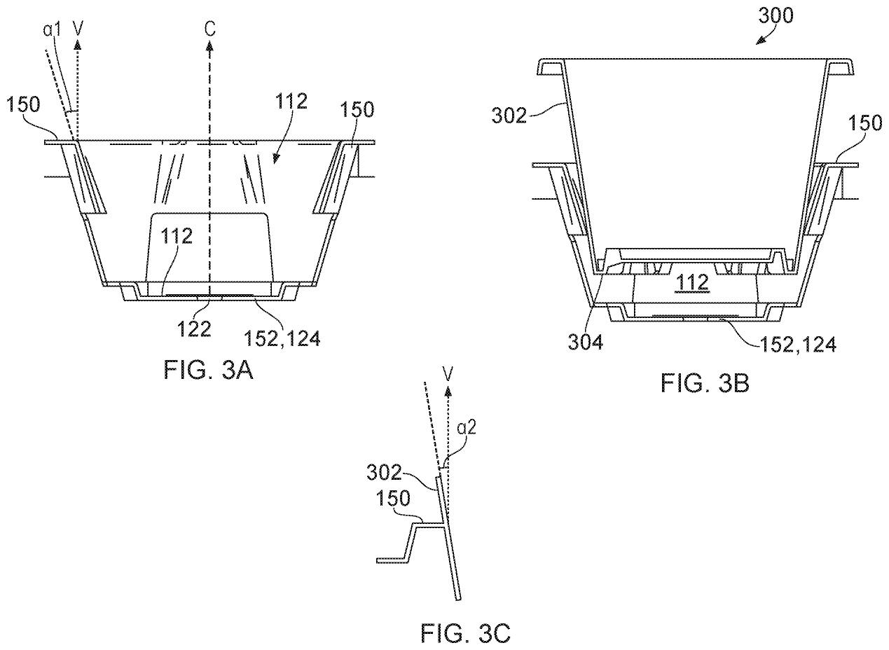

FIG. 3A is a cross-sectional view of a socket of the tray of FIG. 1A, without a pot inserted into the socket;

FIG. 3B is a cross-sectional view of a the socket of FIG. 3A, with a pot partially inserted into the socket; and

FIG. 3C is a cross-sectional partial view of the socket of FIG. 3A, with a pot fully inserted into the socket.

In the drawings, like reference numerals refer to like parts.

Referring to the figures, the present invention comprises a multi-compartment carrier tray 100 (hereinafter referred to as tray 100).

The tray 100 has a horizontal axis H and a vertical axis V, orthogonal to the horizontal axis H. When the tray 100 is laid flat on a level surface, the horizontal axis H lies in a true horizontal plane, and vertical axis V lies in a true vertical plane.

The tray 100 comprises a top 150, a base 152, and a plurality of sockets 102. Each socket 102 can accommodate one plant pot 300 (as shown in FIGS. 2A-2F).

In the illustrated embodiment, the tray 100 comprises eight sockets 102, arranged in parallel two lines, wherein the sockets of one line are slightly offset from the sockets of the other line. However, different embodiments may provide different numbers of sockets 102, and lines of sockets 102 may not be offset from one another.

Each socket 102 comprises a first set of four planar areas 104a, 104b, 104c, 104d, a second set of four planar areas 114a, 114b, 114c, 114d, and a socket base 112. Each socket base 112 has an underside 124; the undersides 124 of the socket bases 112 collectively form the base 152 of the base 152 of the tray; i.e. when the tray 100 is placed level on a flat surface, it will rest upon the undersides 124 of the socket bases 112.

The socket bases 112 are each provided with a central drainage hole 120 (indicated on FIG. 1C), and have a centre point 122 (FIG. 1C). A central vertical axis C (FIG. 1E) is defined vertically upwards from the centre point 122 (i.e. when the tray 100 is laid flat on a horizontal surface, the central vertical axis C will lie in a true vertical direction).

The first set of planar areas 104a-d and the second set of planar areas 114a-d are arranged alternately, and are separated by concertinaed sections 130.

Each of the first set of planar areas 104a-d provides a point of contact when a plant pot is inserted into the socket 102, i.e. each of the first set of planar areas 114a-d will each be in contact with a plant pot 300 when the pot is placed in the socket 102.

The second set of planar areas 114a-d are each recessed with respect to the first set of planar areas 104a-d, i.e. each of the second set of planar areas 114a-d lie further away from the central vertical axis C of the socket 102.

Each of the first set of planar areas 104a-d extends from the top 152 of the tray 100, part-way towards the socket base 112, i.e. each of the first set of planar areas 104a-d stops short of the socket base 112, and is not attached to the socket base 112.

Each of the second set of planar areas 114a-d extend from the top 150 of the tray 100, and are each attached to the base 112 of the socket 102.

The first set of planar areas 104a-d are arranged at an angle to the central vertical axis C of the socket 102. The sockets 102 are provided with a variable geometry, i.e. the angle of the first set of planar areas 104a-d can be varied, as explained below.

In a first, unfulfilled state, i.e. when a plant pot is not present in a socket 102, each of the first set of planar areas 104a-d are at a first or nominal angle, α1 (FIG. 3A), to the central vertical axis C of the socket 102. The first angle α1 is a “kind angle”, and allows empty trays 100 to be stacked closely on top of one another, i.e. the sockets 102 of a first tray 100 to each be inserted into a corresponding socket 102 of a further tray 100 below it in a stack, in a close nested configuration, thereby maximising the cost effectiveness of deliveries. The first angle α1 could be, by way of example, 12°.

Plant pots generally comprise a substantially frustoconical shape formed of a single wall, formed such that the wall is at a known angle to a central vertical axis of the pot. The wall of the plant pot is often steep, for example the angle of the wall to the vertical axis may be 5° (the vertical axis is defined as a true vertical direction when the plant pot is positioned flat on a flat surface).

As indicated on FIG. 2E, an example plant pot 300 has a side wall 302 at an angle P to the vertical axis V. This angle P is less than the first angle α1 of the planar section 104a-d of a socket 102 to the central vertical axis of the socket C. When such a plant pot 300 is inserted into a socket 102, the concertinaed sections 130a-d enable each of the first set of planar sections 104a-b to be urged outwardly with respect the socket 102 (i.e. away from the central vertical axis C of the socket 102), by the side wall 302 of the pot 300 as it is inserted into the socket 102.

Specifically, folds of material forming the concertinaed sections 130 are caused to concertina, i.e. are urged together, by the wall 302 of the pot 300 contacting, and applying pressure to, i.e. pushing against, each of the first set of planar areas 104a-d, as the pot 300 is inserted into the socket 102. The first set of planar sections 104a-d are urged outwardly by an amount which increases towards their lower parts lower sections 105. The second set of planar sections 106a-d however remain in their relative positions as a pot is inserted because they are restrained by attachment at their top parts 118 to the top 150 of the tray, and at their lower parts 116a-d to socket base 112).

As the lower parts 106a-d of the first set of planar sections 104a-d are urged outwardly, the angle of the first set of planar sections 104a-d to the central vertical axis C of the socket 102 decreases. Up to a limit, the angle of the first set of planar sections 104a-d to the vertical axis V will decrease to match the angle of the wall 302 of the plant pot 300 being which is being inserted into the socket 102.

Specifically, the angle of the first set of planar sections 104a-d to the vertical axis decreases from the first angle α1, in the unfulfilled state, to a second angle, α2 (FIG. 3C), in a filled state, i.e. when a plant pot has been fully inserted into the socket 102.

This reduction of angle will occur for a specified range of plant pot wall angles. For example, an angle α1 of 12°, could reduce down to an angle α2 of 5°. In this example, a socket 102 of the tray 100 would be able to accommodate 5° to 12° plant pots, i.e. plant pots comprising a side wall 302 at an angle of between 5° and 12° to the vertical axis V.

The folds of material forming the concertinaed sections 130 are of a sufficient rigidity that the concertinaed sections 130 cause each of the first set of planar sections 104a-d to be biased inwardly with respect to the socket 102, therefore ensuring contact between each of the first set of planar sections 104a-d and the wall of the plant pot 300, once the pot has been fully inserted into the socket 102 (i.e. when a base 304 (FIG. 3B) of the plant pot 300 contacts the socket base 112). The plant pot 300 is therefore gripped by the first set of planar sections 104a-d and is thus maintained securely in place in the socket 102.

Referring to FIG. 2B, multiple sockets 102 within a tray 100 are arranged in close proximity to one another. The close arrangement of adjacent sockets 102 maximises the number of sockets 102 which can be provided per tray. This in turn maximises the number of plant pots 300 which can be provided per unit area, e.g. per trolley shelf.

The arrangement of the sockets 102 within a tray 100, and specifically the proximity of adjacent sockets 102, is also selected so as to enable plant pots of a specific height to be inserted into the sockets. For example, as illustrated in FIG. 2E, a tray 100 can be filled with plant pots 300 which each have a side wall 302 at a specific degree N° to the vertical, and a maximum height Hp. If the height of the plant pots 300 exceeded Hp, the top sections of the plant pots would crushed against one another.

In one example, a tray 100 having eight sockets 102 could be configured to receive eight plant pots. A typical example of plant pot could have a side wall at 8° to the vertical, and a height of 12 cm, however, the tray 100 can accommodate plant pots of various different heights, for example between 10 cm and 13 cm.

Enabling a maximum number of pots 300 of a known height Hp, and having a side wall 302 at known angle the vertical axis, to be carried by a tray 100, and therefore maximising the number of pots 300 per unit space, is achieved by designing a tray 100 such that when the tray is filled with pots 300, the footprints of the pots 300 (i.e. the locus of the pot 300 as viewed from above), are as close as possible to each other, and also as close to the edge of the tray, i.e. to an outer periphery 154 of the tray 100, without overlapping. As seen in FIGS. 2B and 2C, each pot 300 has a maximum footprint which is defined by an area within an outer edge 310 of a rim 308 of the pot 300.

The sockets 102 are arranged such that when pots 300 of known dimensions (specifically of a known height and a known angle of the side wall 302 to the vertical, and therefore of a known footprint), are inserted into each of the sockets 102, the outer edge 310 of a rim 308 of a pot 300 meets, i.e. is immediately adjacent to, an edge 310 of a rim 308 of an adjacent pot 300.

Furthermore, the sockets 102 are arranged such that when a pot 300 of known dimensions is inserted into a socket 102, the outer edge 310 of the rim 308 extends to, but does not exceed, an outer periphery 154 of the tray 100, when viewed from above. In other words, the outer edge 310 of the rim 310 of the pot 300 lies in a vertical plane VP (FIGS. 2D and 2E) defined by the periphery 154 of the tray 100.

The trays 100 can be configured to be reusable. Specifically, the concertinaed sections 130 can be configured to be sufficiently stiff, that they will relax, (i.e. the folds of material forming a concertinaed section 130 will separate from one another), once a plant pot 200 is removed from the socket 102, thereby causing the first set of planar areas 104a-d to be urged back towards the central vertical axis C of the 102 socket and thereby move from the second angle α2, back to the first angle α1. Trays 100 can therefore once again be stacked together in a close configuration ready further use.

The illustrated embodiments are not limiting; for example a different number, or arrangement of sockets could be provided, within the scope of the claims below.

As described above, the “kind” angle of first set of planar areas of the carrier tray of the present invention enables multiple trays 100 to be stacked in close configuration with other carrier trays, and which maximises a number of pots which can be transported per unit area.

Furthermore, by virtue of the variable geometry of the first set of planar areas as described above, the tray of the present invention can securely accommodate various plant pots having side walls at different angles to the vertical.

Furthermore, as described above, the sockets of the tray of the present invention can accommodate a variety of different heights of plant pots. The sockets are configured such that, when used with a plant pot of a predetermined height and angle of side wall, the number of pots per unit space is maximised.

Furthermore, as the concertinaed sections are configured to relax after a plant pot has been removed from a socket, the trays can be restacked ready for re-use.

1-13. (canceled)

14. A tray for carrying plant pots, comprising:
a top, a base, an outer periphery, and a plurality of sockets each of which can receive a plant pot;
wherein the sockets each comprise:
a socket base, undersides of the socket bases collectively forming the base of the tray;
a first set of contact areas, each of which extend from the top of the tray part way towards the socket base and is for contacting a side wall of a plant pot inserted into a respective socket, and
a second set of recessed areas, each of which extend from the top of the tray to the socket base;
wherein the contact areas of the first set are arranged alternately with recessed areas of the second set, and wherein a concertinaed section is provided between a one contact area of the first set of contact areas and an adjacent one recessed area of the second set of recessed areas; and
wherein, when the tray is in a first, unfulfilled state, when a plant pot is not present in a respective socket, the first set of contact areas are each arranged at a first angle to a central vertical axis through a central point of the socket, and when the tray is in a second filled state, when a plant pot has been fully inserted into the respective socket, the first set of contact areas are each arranged at a second angle to the central vertical axis of the socket, wherein the second angle is less than the first angle.

15. A tray as claimed in claim 14 wherein the first set of contact areas comprises four contact areas and the second set of recessed areas comprises four recessed areas.

16. A tray as claimed in claim 14 wherein the recessed areas of the second set of recessed areas are each recessed with respect to the first set of contact areas, whereby each recessed area of the second set of recessed areas lies further away from the central vertical axis than the first set of contact areas.

17. A tray as claimed in claim 14 wherein the first angle is 12°.

18. A tray as claimed in claim 14 wherein the second angle is 5°.

19. A stack of trays, each tray in the stack comprising the tray as claimed in claim 14, wherein each socket of a first tray in the stack is located in a corresponding socket of a further tray located immediately below the first tray in the stack.

20. A method of use of the tray as claimed in claim 14, comprising inserting a plant pot into a socket of the tray, wherein each of the concertinaed sections of the socket comprises folds of material, and wherein insertion of the plant pot into the socket causes a side wall of the plant pot to contact and apply pressure to each of the first set of contact areas, thereby causing the folds of material to be urged together in each respective concertinaed section, thereby enabling each of the first set of contact areas to be urged away from the central vertical axis of the socket, and wherein when insertion of the plant pot into the socket is complete and the plant pot is fully inserted in the socket, the first set of contact areas is each arranged at the second angle.

21. A method of use as claimed in claim 20 comprising a subsequent step of removing the plant pot from the socket thereby causing the concertinaed sections to relax and urge the first set of contact areas back towards the central vertical axis of the socket, and wherein when removal of the plant pot from the socket is complete, the first set of contact areas is each arranged at the first angle.

22. A system comprising the tray as claimed in claim 14, and at least one plant pot, wherein each plant pot of the at least one plant pot is insertable in a socket of the tray;
wherein when a plant pot of the at least one plant pot is present in a socket of the tray and a base of the plant pot is in contact with the socket base, each of the first set of contact areas is in contact with a side wall of the plant pot, and an angle of the side wall of the plant pot is equal to the second angle of the first set of contact areas to the central vertical axis of the socket.

23. A system as claimed in claim 22 wherein, when the at least one plant pot is present in the socket of the tray, an edge of a rim of the at least one plant pot is coincident with a vertical plane defined by the outer periphery of the tray.

24. A system as claimed in claim 22 wherein, when a plant pot is present in each one of the sockets, an edge of a rim of each of the plant pots lies within a footprint defined within periphery vertical planes defined by the outer periphery of the tray.

25. A system as claimed in claim 22 wherein an edge of a rim of the at least one plant pot is immediately adjacent to an edge of a rim of a further plant pot in an adjacent socket.

26. A system as claimed in claim 22 wherein the or each plant pot is between 10 cm and 13 cm in height.

27. A system as claimed in claim 22 wherein the side wall of the or each plant pot is at an angle of between 5° and 12° to a vertical axis.
